(19) United States
(12) Patent Application Publication
(10) Pub. No.: US 2022/0353578 A1
(43) Pub. Date: Nov. 3, 2022

(54) ARTIFICIAL INTELLIGENCE INFORMATION PROCESSING APPARATUS, ARTIFICIAL INTELLIGENCE INFORMATION PROCESSING METHOD, AND ARTIFICIAL-INTELLIGENCE-FUNCTION-EQUIPPED DISPLAY APPARATUS

(71) Applicant: SONY GROUP CORPORATION, TOKYO (JP)

(72) Inventors: MASANORI MATSUSHIMA, TOKYO (JP); HIROYUKI CHIBA, TOKYO (JP); TOSHIHIKO FUSHIMI, TOKYO (JP); YOSHIYUKI KOBAYASHI, TOKYO (JP)

(21) Appl. No.: 17/624,204

(22) PCT Filed: Apr. 27, 2020
(86) PCT No.: PCT/JP2020/018030

§ 371 Date: Dec. 30, 2021

(30) Foreign Application Priority Data
Jul. 12, 2019 (JP) 2019-130274

(51) Int. Cl. H04N 21/466

(52) U.S. Cl. CPC H04N 21/4666; H04N 21/4667

(57) ABSTRACT

An information processing apparatus that performs an automatic operation of equipment by artificial intelligence is provided. An artificial intelligence information processing apparatus includes a control section that estimates and controls the operation of the equipment by artificial intelligence on the basis of sensor information, and a presentation section that estimates and presents a reason that the control section has performed the operation of the equipment by artificial intelligence on the basis of the sensor information, the presentation section, as estimating the operation by the artificial intelligence, estimating the reason that the operation of the equipment has been performed by using a first neural network that has learnt a correlation between the sensor information and the operation of the equipment and the reason that the operation of the equipment has been performed.

### TECHNICAL FIELD

A technology disclosed herein relates to an artificial intelligence information processing apparatus, an artificial intelligence information processing method, and an artificial-intelligence-function-equipped display apparatus that perform an automatic operation of equipment by artificial intelligence.

### BACKGROUND ART

Television broadcast services have been widely used for a long time. Television receivers are currently widely used, and one or multiple receivers are installed at each home. Broadcasting or Internet-streaming moving-image distribution services such as IPTV (Internet Protocol TV) and OTT (Over-The-Top) have recently been becoming more popular.

A variety of operations, such as turning on/off the television, switching channels, adjusting the volume, and switching the input, are usually performed via a remote controller. Televisions have recently been more frequently operated via a voice agent such as an AI (Artificial Intelligence) speaker. For example, there is provided a proposal on a voice recognition operation apparatus that provides a television zapping function that follows voice instructions of a user (see PTL 1).

### CITATION LIST

### Patent Literature

[PTL 1]
Japanese Patent Laid-Open No. 2015-39071
[PTL 2]
Japanese Patent No. 4915143
[PTL 3]
Japanese Patent Laid-Open No. 2007-143010

### SUMMARY

### Technical Problem

An object of a technology disclosed herein is to provide an artificial intelligence information processing apparatus, an artificial intelligence information processing method, and an artificial-intelligence-function-equipped display apparatus that perform an automatic operation of equipment such as a television reception apparatus by artificial intelligence.

### Solution to Problem

A first aspect of a technology disclosed herein is an artificial intelligence information processing apparatus including a control section configured to estimate an operation of equipment by artificial intelligence on the basis of sensor information and control the operation, and a presentation section configured to estimate a reason that the control section has performed the operation of the equipment by the artificial intelligence on the basis of the sensor information and present the reason.

As estimating the operation by the artificial intelligence, the presentation section is configured to estimate the reason that the operation of the equipment has been performed by using a first neural network that has learnt a correlation between the sensor information and the operation of the equipment and the reason that the operation of the equipment has been performed. Further, as estimating the operation by the artificial intelligence, the control section is configured to estimate the operation of the equipment responsive to the sensor information by using a second neural network that has learnt a correlation between the sensor information and the operation of the equipment.

Further, a second aspect of the technology disclosed herein is an artificial intelligence information processing method including a control step of estimating and controlling an operation of equipment by artificial intelligence on the basis of sensor information, and a presentation step of estimating and presenting a reason that the control section has performed the operation of the equipment by the artificial intelligence on the basis of the sensor information.

Further, a third aspect of the technology disclosed herein is an artificial-intelligence-function-equipped display apparatus equipped with an artificial intelligence function and configured to display a video, the artificial-intelligence-function-equipped display apparatus including a display section, an acquirement section configured to acquire sensor information, a control section configured to estimate an operation of the artificial-intelligence-function-equipped display apparatus by artificial intelligence on the basis of the sensor information and control the operation, and a presentation section configured to estimate a reason that the control section has performed the operation of the artificial-intelligence-function-equipped display apparatus by the artificial intelligence on the basis of the sensor information and cause the display section to present the reason.

### Advantageous Effects of Invention

According to the technology disclosed herein, it is possible to provide an artificial intelligence information processing apparatus, an artificial intelligence information processing method, and an artificial-intelligence-function-equipped display apparatus that estimate an automatic operation of equipment by artificial intelligence and perform it, and estimate a cause or a reason for having performed the automatic operation by artificial intelligence and present it.

It should be noted that the effect disclosed herein is merely by way of example and effects provided by the technology disclosed herein are not limited thereto. Further, the technology disclosed herein may achieve another additional effect in addition to the above-described effect.

Another object, feature, and advantage of the technology disclosed herein will be made clear by a detailed description based on a later-described embodiment and the attached drawings.

### BRIEF DESCRIPTION OF DRAWINGS

FIG. 1 illustrates a configuration example of a system for viewing/listening to video content.

FIG. 2 illustrates a configuration example of a television reception apparatus 100.

FIG. 3 illustrates an application example of a panel-speaker technology.

FIG. 4 illustrates a configuration example of a sensor group 400 provided in the television reception apparatus 100.

FIG. 5 illustrates a configuration example of an automatic operation estimation neural network 500.

FIG. 6 illustrates a configuration example of a presentation estimation neural network 600.

FIG. 7 illustrates a configuration example of an automatic operation and presentation system 700.

FIG. 8 is a flowchart illustrating a procedure of processing that is to be performed by the automatic operation and presentation system 700.

FIG. 9 illustrates a configuration example of an artificial intelligence system 900 by use of a cloud.

FIG. 10 illustrates a working example of the automatic operation estimation neural network 500.

FIG. 11 illustrates a working example of the presentation estimation neural network 600.

FIG. 12 illustrates a working example of the presentation estimation neural network 600.

### DESCRIPTION OF EMBODIMENT

A detailed description will be made below on an embodiment of a technology disclosed herein with reference to the drawings.

### A. System Configuration

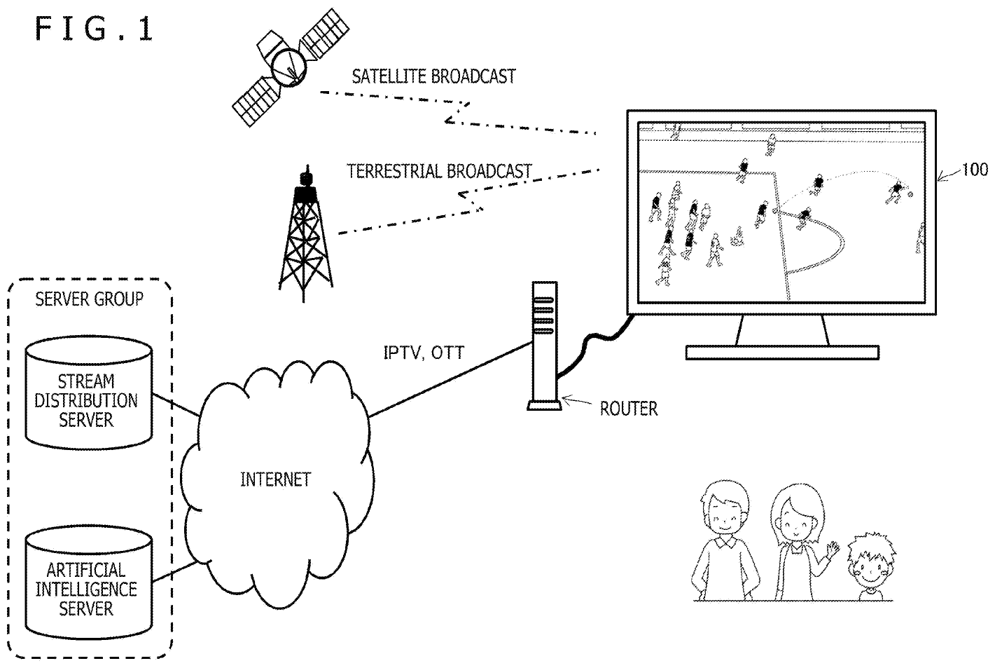

FIG. 1 schematically illustrates a configuration example of a system for viewing/listening to video content.

A television reception apparatus 100 is provided with a large-sized screen that displays video content and a speaker that outputs audio. The television reception apparatus 100 in which, for example, a built-in tuner for selectively receiving a broadcast signal is provided or to which a set-top box equipped with a tuner function is externally connected is capable of using a broadcast service provided by a television station. The broadcast signal may be a ground wave or a satellite wave.

Further, the television reception apparatus 100 is also capable of using, for example, a broadcasting moving-image distribution service through a network such as the IPTV or the OTT. Accordingly, the television reception apparatus 100 is provided with a network interface card and mutually connected to an external network such as the Internet via a router or via an access point through communication compliant with existing communications standards such as Ethernet (registered trademark) or Wi-Fi (registered trademark). In terms of an aspect of function, the television reception apparatus 100 also serves as a display-equipped content acquirement apparatus or a content reproduction apparatus or a display apparatus having a function to acquire or reproduce a variety of types of content and that acquires a variety of reproduction content, such as a video and audio, by a broadcast wave or by streaming or downloading through the Internet to present the pieces of content to a user.

A stream distribution server that distributes a video stream is installed on the Internet, providing a broadcasting moving-image distribution service to the television reception apparatus 100.

An endless number of servers that provide a variety of services are also installed on the Internet. An example of the servers is a stream distribution server that provides a distribution service of a broadcasting moving-image stream through, for example, a network such as the IPTV or the OTT. On a television reception apparatus 100 side, a stream distribution service can be used by starting a browser function and issuing, for example, an HTTP (Hyper Text Transfer Protocol) request to the stream distribution server.

Further, in the present embodiment, it is assumed that there is also an artificial intelligence server that provides, on the Internet (or on a cloud), a function of artificial intelligence to a client. Here, the function of artificial intelligence refers to, for example, a function typically achievable by a human brain, such as learning, inference, data creation, or planning, and that is artificially implemented by software or hardware. Further, the artificial intelligence server is equipped with, for example, a neural network that performs deep learning (DL) by using a model that resembles a brain neural circuit of a human being. The neural network has a mechanism where artificial neurons (nodes), which form a network by virtue of synaptic connection, acquire an ability to solve a problem while changing a strength of the synaptic connection through learning. The neural network is capable of automatically inferring a rule for solving a problem by repetition of learning. It should be noted that the “artificial intelligence server” herein is not limited to a single server apparatus and may be in the form of, for example, a cloud that provides a cloud computing service.

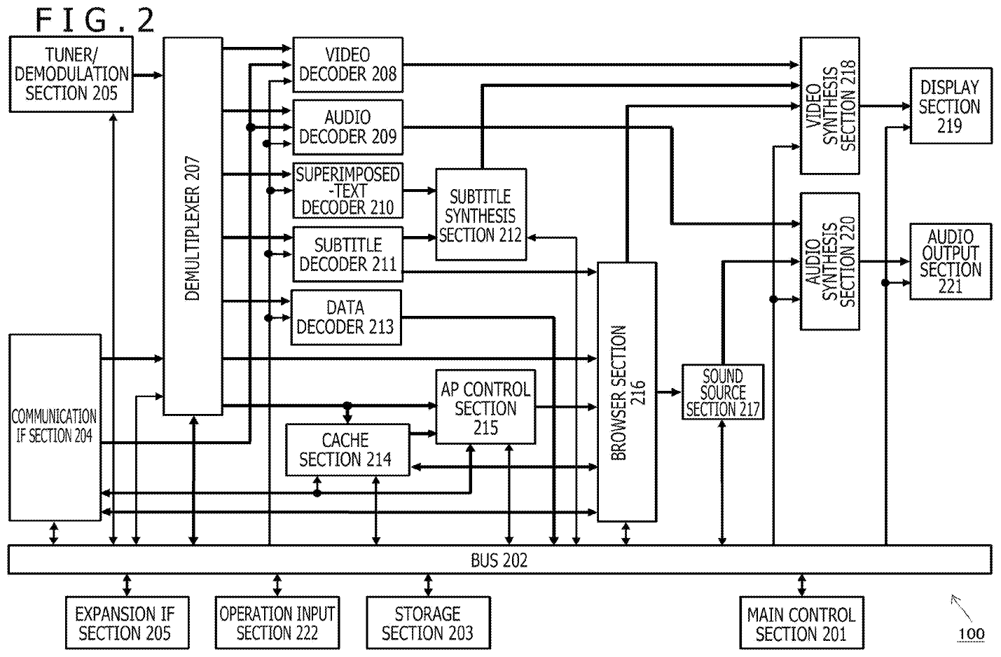

FIG. 2 illustrates a configuration example of the television reception apparatus 100. The television reception apparatus 100 includes a main control section 201, a bus 202, a storage section 203, a communication interface (IF) section 204, an expansion interface (IF) section 205, a tuner/demodulation section 206, a demultiplexer (DEMUX) 207, a video decoder 208, an audio decoder 209, a superimposed-text decoder 210, a subtitle decoder 211, a subtitle synthesis section 212, a data decoder 213, a cache section 214, an application (AP) control section 215, a browser section 216, a sound source section 217, a video synthesis section 218, a display section 219, an audio synthesis section 220, an audio output section 221, and an operation input section 222. It should be noted that the tuner/demodulation section 206 may be externally provided. For example, external equipment equipped with tuner and demodulation functions, such as a set-top box, may be connected to the television reception apparatus 100.

The main control section 201 includes, for example, a controller, a ROM (Read Only Memory) (however, a rewritable ROM such as an EEPROM (Electrically Erasable Programmable ROM) should be included), and a RAM (Random Access Memory) and collectively controls working of the television reception apparatus 100 as a whole in line with a predetermined working program. The controller includes a CPU (Central Processing Unit), an MPU (Micro Processing Unit), a GPU (Graphics Processing Unit), a GPGPU (General Purpose Graphic Processing Unit), or the like. The ROM is a non-volatile memory where a basic working program such as an operating system (OS) and other working programs are held. A working set value necessary for the working of the television reception apparatus 100 may be stored in the ROM. The RAM serves as a work area during execution of the OS or any other working program. The bus 202 is a data communication path for sending and receiving data between the main control section 201 and the sections in the television reception apparatus 100.

The storage section 203 includes a non-volatile storage device such as a flash ROM, an SSD (Solid State Drive), or an HDD (Hard Disc Drive). The storage section 203 stores the working programs and the working set value of the television reception apparatus 100, personal information regarding a user who uses the television reception apparatus 100, etc. Further, the storage section 203 stores a working program downloaded through the Internet and a variety of data created by the working program. Further, the storage section 203 can also store pieces of content such as a moving image, a still image, and audio acquired by using a broadcast wave or by streaming or downloading through the Internet.

The communication interface section 204, which is connected to the Internet via a router (described above) or the like, sends/receives data to/from server apparatuses and other pieces of communication equipment on the Internet. Further, the communication interface section 204 is configured to also acquire a data stream of a program transmitted through a communication line. The router may be wired connection such as Ethernet (registered trademark) or wireless connection such as Wi-Fi (registered trademark).

The tuner/demodulation section 206 receives a broadcast wave for terrestrial broadcast, satellite broadcast, or the like through an antenna (not illustrated) and tunes to (selects) a channel of a service (e.g., a broadcaster) as desired by a user on the basis of a control of the main control section 201. Further, the tuner/demodulation section 206 acquires a broadcast data stream by demodulating a received broadcast signal. It should be noted that, for the purpose of simultaneously displaying a plurality of screens, recording a program in a competing time slot, or the like, the television reception apparatus 100 may include a plurality of tuner/demodulation sections (i.e., a multi-tuner).

The demultiplexer 207 distributes, on the basis of a control signal in an inputted broadcast data stream, real-time presentation elements, that is, a video stream, an audio stream, a superimposed-text data stream, and a subtitle data stream, to the video decoder 208, the audio decoder 209, the superimposed-text decoder 210, and the subtitle decoder 211, respectively. The data to be inputted to the demultiplexer 207 includes data provided by a broadcast service or a distribution service such as the IPTV or the OTT. The former is to be inputted to the demultiplexer 207 after selectively received and demodulated by the tuner/demodulation section 206, whereas the latter is to be inputted to the demultiplexer 207 after received by the communication interface section 204. Further, the demultiplexer 207 reproduces a multimedia application or a constituent element thereof, or file-based data, and outputs it to the application control section 215 or causes the cache section 214 to temporarily store it.

The video decoder 208 decodes the video stream inputted from the demultiplexer 207 and outputs video information. Further, the audio decoder 209 decodes the audio stream inputted from the demultiplexer 207 and outputs audio information. For digital broadcast, for example, a video stream and an audio stream, each of which is encoded in line with MPEG2 System standards, are multiplexed and transmitted or distributed. The video decoder 208 and the audio decoder 209 are to perform decode processing on the encoded video stream and the encoded audio stream, which are demultiplexed by the demultiplexer 207, in line with standardized decode schemes, respectively. It should be noted that, in order to simultaneously perform decoding processing on a plurality of types of video streams and audio streams, the television reception apparatus 100 may include a plurality of video decoders 208 and audio decoders 209.

The superimposed-text decoder 210 decodes the superimposed-text data stream inputted from the demultiplexer 207 and outputs superimposed-text information. The subtitle decoder 211 decodes the subtitle data stream inputted from the demultiplexer 207 and outputs subtitle information. The subtitle synthesis section 212 performs processing to combine the superimposed-text information outputted from the superimposed-text decoder 210 and the subtitle information outputted from the subtitle decoder 211.

The data decoder 213 decodes a data stream multiplexed into an MPEG-2 TS stream with a video and audio. For example, the data decoder 213 notifies the main control section 201 of a result of decoding a general-purpose event message held in a descriptor area of one of PSI (Program Specific Information) tables, or PMT (Program Map Table).

The application control section 215 receives input of control information, which is contained in the broadcast data stream, from the demultiplexer 207 or acquires the control information from a server apparatus on the Internet via the communication interface section 204 and interprets the control information.

The browser section 216 presents a multimedia application file acquired from a server apparatus on the Internet via the cache section 214 or the communication interface section 204 or a constituent element thereof, or file-based data, in line with instructions of the application control section 215. Examples of the multimedia application file here include an HTML (Hyper Text Markup Language) document and a BML (Broadcast Markup Language) document. Further, the browser section 216 is configured to also reproduce audio information regarding the application by encouraging the sound source section 217.

The video synthesis section 218 receives input of the video information outputted from the video decoder 208, the subtitle information outputted from the subtitle synthesis section 212, and the application information outputted from the browser section 216 and performs processing for appropriate selection or superimposition. The video synthesis section 218 includes a video RAM (illustration thereof is omitted), and the display section 219 is driven for display on the basis of video information inputted to the video RAM. Further, the video synthesis section 218 also performs, on the basis of the control of the main control section 201, processing to superimpose screen information, such as an EPG (Electronic Program Guide) screen or a graphic generated by an application run by the main control section 201, if necessary.

The display section 219 presents a screen displaying the video information selected or subjected to the superimposition processing by the video synthesis section 218 to a user. The display section 219 is a display device in the form of, for example, a liquid crystal display, an organic EL (Electro-Luminescence) display, a self-luminous display (for example, a crystal LED display) including fine LED (Light Emitting Diode) elements as pixels, or the like. Alternatively, a display device to which a partial driving technology in which the screen is divided into a plurality of areas and brightness is controlled on an area-basis is applied may be used as the display section 219. A display including a transmissive liquid crystal panel is advantageous in that a luminance contrast is improved by causing a backlight corresponding to an area with a high signal level to be lit brightly while causing a backlight corresponding to an area with a low signal level to be dimmed. A partially driving display device can achieve a high dynamic range by increasing the luminance when partial white-light display is performed (with an output power of the backlights as a whole kept constant) by using a thrusting technology in which an electric power saved at a dammed part is distributed to an area with a high signal level to cause a concentrative light emission (see, for example, PTL 2).

The audio synthesis section 220 receives input of the audio information outputted from the audio decoder 209 and the audio information regarding the application reproduced by the sound source section 217 and performs processing such as appropriate selection or synthesis.

The audio output section 221 is used for output of audio of program content or data broadcast content selectively received by the tuner/demodulation section 206 or output of the audio information processed by the audio synthesis section 220 (e.g., a synthetic voice of a voice guidance or a voice agent). The audio output section 221 includes a sound generation device such as a speaker. For example, the audio output section 221 may be a speaker array including a plurality of combined speakers (a multi-channel speaker or a supermulti-channel speaker) or some or all of the speakers may be externally connected to the television reception apparatus 100. The external speaker may be in the form of a sound bar or the like to be provided in front of a television or may be in the form of a wireless speaker or the like to be wirelessly connected to a television. Further, a speaker connectable to another audio product via an amplifier or the like is also acceptable. Alternatively, the external speaker may be a smartspeaker, a wireless headphone/head set, a tablet, a smartphone, or a PC (Personal Computer) that is equipped with a speaker and capable of voice input, a generally-called smart home appliance such as a refrigerator, a washing machine, an air conditioner, a vacuum cleaner, or a lighting fixture, or an IoT (Internet of Things) home appliance apparatus.

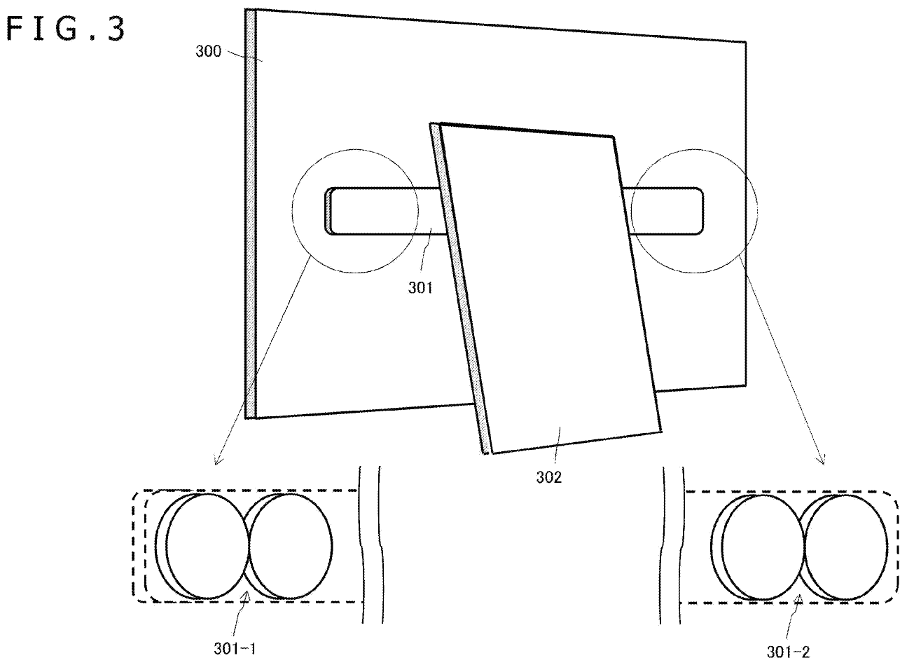

In addition to a cone-shaped speaker, a flat-panel-shaped speaker (for example, see PTL 3) is also usable as the audio output section 221. A speaker array including combined different types of speakers is, of course, also usable as the audio output section 221. Alternatively, the speaker array may include a speaker that outputs audio by causing the display section 219 to vibrate with the assistance of one or more shakers (actuators) that generate vibrations. The shaker (actuator) may be in a form capable of being added to the display section 219 later. FIG. 3 illustrates an example of application of a panel-speaker technology to a display. A display 300 is supported by a stand 302 therebehind. A speaker unit 301 is attached to a rear surface of the display 300. A shaker 301-1 is provided at a left end of the speaker unit 301, whereas a shaker 301-2 is provided on a right end thereof, thus providing a speaker array. The shakers 301-1 and 301-2 cause the display 300 to vibrate on the basis of left and right audio signals, respectively, thereby making it possible to output sound. The stand 302 may include a built-in subwoofer that outputs a low-pitched sound. It should be noted that the display 300 corresponds to the display section 219 including an organic EL element.

Referring back to FIG. 2 again, description will be made on the configuration of the television reception apparatus 100. The operation input section 222 is an instruction input section for a user to input operation instructions to the television reception apparatus 100. The operation input section 222 includes, for example, a remote controller reception section that receives a command sent from a remote controller (not illustrated) and an operation key with button switches arranged side by side. Further, the operation input section 222 may also include a touch panel overlaid on a screen of the display section 219. Further, the operation input section 222 may also include an external input device such as a keyboard connected to the expansion interface section 205.

The expansion interface section 205, which is an interface group for expansion of a function of the television reception apparatus 100, includes, for example, an analog video/audio interface, a USB (Universal Serial Bus) interface, a memory interface, or the like. The expansion interface section 205 may include a digital interface including a DVI terminal, an HDMI (R) terminal, a Display Port (registered trademark) terminal, or the like.

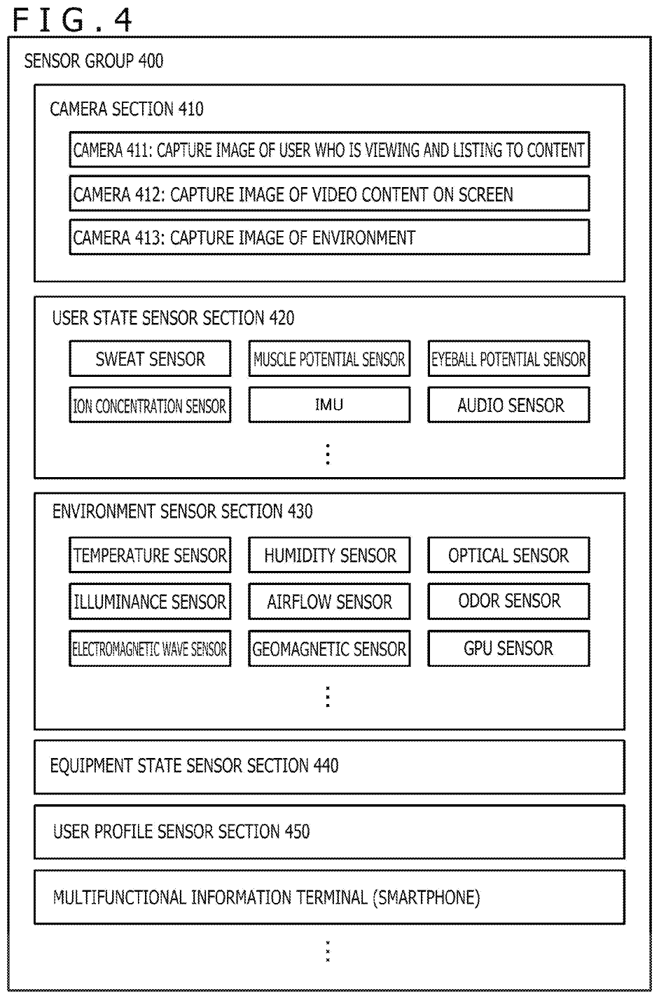

In the present embodiment, the expansion interface 205 is also usable as an interface for taking sensor signals from a variety of sensors included in a sensor group (see a description thereof below and FIG. 4). The sensors should include both of a sensor provided inside a body of the television reception apparatus 100 and a sensor externally connected to the television reception apparatus 100. The externally connected sensor also includes a built-in sensor provided in any other CE (Consumer Electronics) equipment or IoT device present in the same space as the television reception apparatus 100. The expansion interface 205 may take a sensor signal after subjecting it to signal processing such as denoising and, further, to digital conversion or may take a sensor signal as unprocessed RAW data (an analog-waveform signal).

### B. Sensing Function

One of purposes of the television reception apparatus 100 being provided with the variety of sensors is to achieve automation of a user operation on the television reception apparatus 100. Examples of the user operation on the television reception apparatus 100 include turning on and off, channel switching (or automatic channel selection), input switching (switching to a stream distributed by an OTT service, input switching to recording equipment or Blu-ray reproduction equipment, or the like), volume adjustment, screen brightness adjustment, picture quality adjustment, and the like.

It should be noted that, in a case where the “user” is simply mentioned herein, the user refers to, unless otherwise specified, a viewer/listener who views/listens to (or may be going to view/listen to) video content displayed on the display section 219.

FIG. 4 illustrates a configuration example of a sensor group 400 provided in the television reception apparatus 100. The sensor group 400 includes a camera section 410, a user state sensor section 420, an environment sensor section 430, an equipment state sensor section 440, and a user profile sensor section 450.

The camera section 410 includes a camera 411 that captures an image of a user who is viewing/listening to video content displayed on the display section 219, a camera 412 that captures an image of the video content displayed on the display section 219, and a camera 413 that captures an image of a room interior (or an installation environment) where the television reception apparatus 100 is installed.

The camera 411, which is installed, for example, in the vicinity of a middle of an upper edge of the screen of the display section 219, favorably captures an image of the user who is viewing/listening to the video content. The camera 412, which is installed, for example, opposite the screen of the display section 219, captures the video content currently viewed/listened to by the user. Alternatively, the user may wear a goggle equipped with the camera 412. Further, the camera 412 should be equipped with a function to also record the audio of the video content together. Further, the camera 413, which is provided by, for example, a whole-sky camera or a wide-angle camera, captures the room interior (or the installation environment) where the television reception apparatus 100 is installed. Alternatively, the camera 413 may be, for example, a camera mounted on a camera table (a camera platform) configured to be driven for rotation around each of roll, pitch, and yaw axes. However, in a case where the environment sensor 430 is sufficient to acquire sufficient environmental data or the environment data itself is not necessary, the camera 410 is not necessary.

The user state sensor section 420 includes one or more sensors that acquire state information regarding a state of the user. The user state sensor section 420 is designed to acquire, as the state information, for example, a working state of the user (whether or not the video content is viewed/listened to), an action state of the user (a movement state such as staying, walking, or running, an open/close state of eyelids, a direction of a line of sight, a size of a pupil), a mental state (for example, whether or not the user is absorbed in or concentrating on video content: an impression level, an excitement level, an arousal level, feelings and emotions, etc.), and even a physiological state. The user state sensor section 420 may also include a variety of sensors, such as a sweat sensor, a muscle potential sensor, an eyeball potential sensor, a brain wave sensor, a breath sensor, a gas sensor, an ion concentration sensor, and an IMU (Inertial Measurement Unit) that measures a behavior of the user, and an audio sensor (e.g., a microphone) that collects speech of the user. It should be noted that the microphone is not necessarily integrated with the television reception apparatus 100 and may be a microphone installed in a product such as a soundbar provided in front of a television. Alternatively, external microphone-equipped equipment that is connectable by wire or wirelessly may be used. The external microphone-equipped equipment may be a smartspeaker, a wireless headphone/head set, a tablet, a smartphone, or a PC that is equipped with a microphone and capable of voice input, a generally-called smart home appliance such as a refrigerator, a washing machine, an air conditioner, a vacuum cleaner, or a lighting fixture, or an IoT home appliance apparatus.

The environment sensor section 430 includes a variety of sensors that measure information regarding an environment such as a room interior where the television reception apparatus 100 is installed. For example, the environment sensor section 430 includes a temperature sensor, a humidity sensor, an optical sensor, an illuminance sensor, an airflow sensor, an odor sensor, an electromagnetic wave sensor, a geomagnetic sensor, a GPS (Global Positioning System) sensor, an audio sensor (e.g., a microphone) that collects an ambient sound, etc.

The equipment state sensor section 440 includes one or more sensors that acquire a state of an inside of the television reception apparatus 100. Alternatively, a circuit component such as the video decoder 208 or the audio decoder 209 may have a function to externally output a state of an input signal, a processing status of the input signal, or the like, functioning as a sensor that detects the state of the inside of the equipment. Further, the equipment state sensor section 440 may detect an operation performed by the user on the television reception apparatus 100 or other pieces of equipment or store a history of previous operations of the user.

The user profile sensor section 450 detects profile information regarding the user who views/listens to video content on the television reception apparatus 100. The user profile sensor section 450 is not necessarily provided by a sensor element. For example, a user profile including age and sex of the user may be detected on the basis of an image of a face of the user captured by the camera 411 or speech of the user collected by the audio sensor. Further, a user profile acquired on a multifunctional information terminal such as a smartphone carried by the user may be acquired by virtue of cooperation between the television reception apparatus 100 and the smartphone. However, the user profile sensor section does not need to detect even confidential information that may relate to privacy or secret of the user. Further, it is not necessary to detect the profile of the same user every time when video content is viewed/listened to and the once acquired user profile information may be stored in, for example, the EEPROM (described above) in the main control section 201.

Further, the multifunctional information terminal such as a smartphone carried by the user may be used as the user state sensor section 420, the environment sensor section 430, or the user profile sensor section 450 by virtue of cooperation between the television reception apparatus 100 and the smartphone. For example, sensor information acquired by a built-in sensor provided in the smartphone and/or data that is to be managed by an application such as a healthcare function (e.g., a pedometer), a calendar or a diary/memorandum, a mail, or an SNS (Social Network Service) may be added to the state data regarding the user or the environment data. Further, a built-in sensor provided in any other CE equipment or IoT device present in the same space as the television reception apparatus 100 may be used as the user state sensor section 420 or the environment sensor section 430. Further, it may be detected that a visitor has come by detecting a sound from an intercom or through communication with an intercommunication.

### C. Automatic Operation of Equipment by Sensing

By virtue of combination with the sensing functions as illustrated in FIG. 4, the television reception apparatus 100 according to the present embodiment can achieve automation of a user operation which may be performed by a remote controller, voice input, or the like at the present time (before the present application).

For example, it is convenient if a television is automatically turned on with a regularly watched channel selected when the user wakes up and cannot find a remote controller or when both hands are busy carrying baggage immediately after the user comes home. Further, if a television is automatically turned off when the user goes away from the front of the television reception apparatus 100 or when bedtime comes (or the user falls asleep while watching the television), the room becomes quiet, and additionally, energy is saved.

Further, if the luminance of the display section 219 or the intensity of the backlight is automatically adjusted according to the brightness of the room interior, the condition of the eyes of the user, or the like or if adjustment of picture quality, conversion of resolution, or the like is performed according to a quality of an original image of a video stream received by the tuner/demodulation section 206, the user can easily see the video with friendliness to the eyes.

Further, if the volume of the audio output section 221 is automatically adjusted according to a surrounding environment, a working status of the user, or the like or if a sound quality is adjusted according to an original sound quality of an audio stream received by the tuner/demodulation section 206 or the like, the user can easily hear the audio of the television, and in some cases, the audio of the television is prevented from disturbing the user. For example, if the volume of the television is automatically increased immediately after the user wakes up or when there is an ambient noise (e.g., a noise from a neighboring construction site), the user can easily hear the audio of the television without the necessity of operating a remote controller.

In contrast, if the volume of the television is spontaneously lowered when the user starts a call on the smartphone or starts conversation with a family member entering the room, the call or conversion is prevented from being disturbed by the audio of the television. In this case, the user does not need to set or cancel mute by operating a remote controller or the like. Alternatively, instead of completely deadening the audio of the television, the volume may be automatically lowered to a minimum necessary level.

The present embodiment is mainly characterized in that the automatic operation of the television reception apparatus 100 is achieved by using a neural network having learnt a correlation between sensor information and an operation performed by a user on the television reception apparatus 100 for estimation of an operation by artificial intelligence.

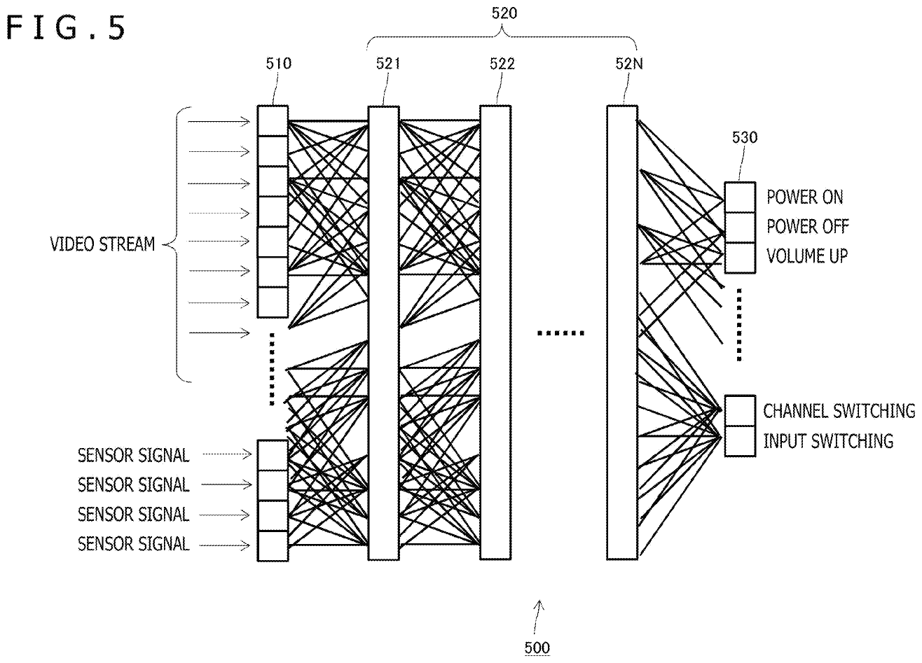

FIG. 5 illustrates a configuration example of an automatic operation estimation neural network 500 contributing to the automatic operation of the television reception apparatus 100. The automatic operation estimation neural network 500 includes an input layer 510 where an image captured by the camera 411 and other sensor signals are to be inputted, an intermediate layer 520, and an output layer 530 that outputs an operation on the television reception apparatus 10. In the illustrated example, the intermediate layer 520 includes a plurality of intermediate layers 521, 522, . . . and the automatic operation estimation neural network 500 can perform DL. It should be noted that, in consideration of time-series information such as a moving image or audio being processed as a sensor signal, the intermediate layer 520 may have a recurrent neural network (RNN) structure containing reflexive join.

The input layer 510 contains one or more input nodes that individually receive one or more sensor signals contained in the sensor group 400 illustrated in FIG. 4. Further, the input layer 510 contains a moving image stream (or a still image is also acceptable) captured by the camera 411 as an input vector element. Basically, the image signal captured by the camera 411 is to be inputted to the input layer 510 while remaining as RAW data.

It should be noted that, in a case where sensor signals from other sensors are also used for estimation of the automatic operation in addition to the image captured by the camera 411, a configuration where input nodes corresponding to the respective sensor signals are additionally arranged in the input layer 510 is employed. Further, a convolutional neural network (CNN) may be used for input of an image signal or the like, thereby performing condensation processing of a feature point.

On the basis of the sensor information acquired by the sensor group 400, the state of the user, a surrounding environment of a location where the television reception apparatus 100 is installed, or the like at that point of time is estimated. Further, the output layer 530 contains a plurality of output nodes corresponding to a variety of respective operations on the television reception apparatus 100, such as ON/OFF of the television reception apparatus 100, channel switching, input switching, picture quality adjustment, brightness adjustment, volume-up, and volume-down. Then, in response to input of the sensor information to the input layer 510, one of the output nodes corresponding to an equipment operation that seems to be reasonable according to the state of the user or the surrounding environment at that time fires.

During a learning process of the automatic operation estimation neural network 500, a correlation between the state of the user or the surrounding environment, and the operation of the television reception apparatus 100 is learnt by inputting a huge number of combinations of images of the user or other sensor signals and appropriate (or ideal) operations on the television reception apparatus 100 to the automatic operation estimation neural network 500 and updating respective weight coefficients of the nodes in the intermediate layer 520 such that the strength of connection with output nodes for equipment operations that seem to be reasonable with respect to the images of the user or the other sensor signals increases. For example, sensor information resulting from a variety of operations, such as turning on/off, adjusting the volume, adjusting the picture quality, switching the channel, and switching the input device, being performed by the user on the operation television reception apparatus 100 is inputted to the automatic operation estimation neural network 500 as teaching data. The automatic operation estimation neural network 500 then sequentially discovers, from an action of the user, the state of the user, the surrounding environment, or the like prior to the operations being performed, conditions for any one of the operations to be performed on the television reception apparatus 100.

Then, during an identification (equipment operation) process of the automatic operation estimation neural network 500, the automatic operation estimation neural network 500 highly accurately outputs, in response to detecting that conditions for any one of the operations to be performed on the television reception apparatus 100 are satisfied according to the inputted image of the user or the other sensor signals, an appropriate operation of the television reception apparatus 100. The main control section 201 collectively controls working of the television reception apparatus 100 as a whole in order to perform the operation outputted from the output layer 530.

The automatic operation estimation neural network 500 as illustrated in FIG. 5 is implemented in, for example, the main control section 201. Accordingly, a processor dedicated for a neural network may be included in the main control section 201. Alternatively, the automatic operation estimation neural network 500 may be provided by a cloud on the Internet; however, in order to automatically operate the television reception apparatus 100 in real time according to the action of the user, the state of the user, or the surrounding environment, it is preferable that the automatic operation estimation neural network 500 be provided in the television reception apparatus 100.

For example, the television reception apparatus 100 incorporated with the automatic operation estimation neural network 500 having completed learning by using an expert teaching database is shipped. The automatic operation estimation neural network 500 may continuously learn by an algorithm such as back propagation (inverse error propagation). Alternatively, the automatic operation estimation neural network 500 in the television reception apparatus 100 installed at each home can be updated with a result of learning performed on the basis of data collected from a huge number of users on a cloud side on the Internet. Description will be made on this point later.

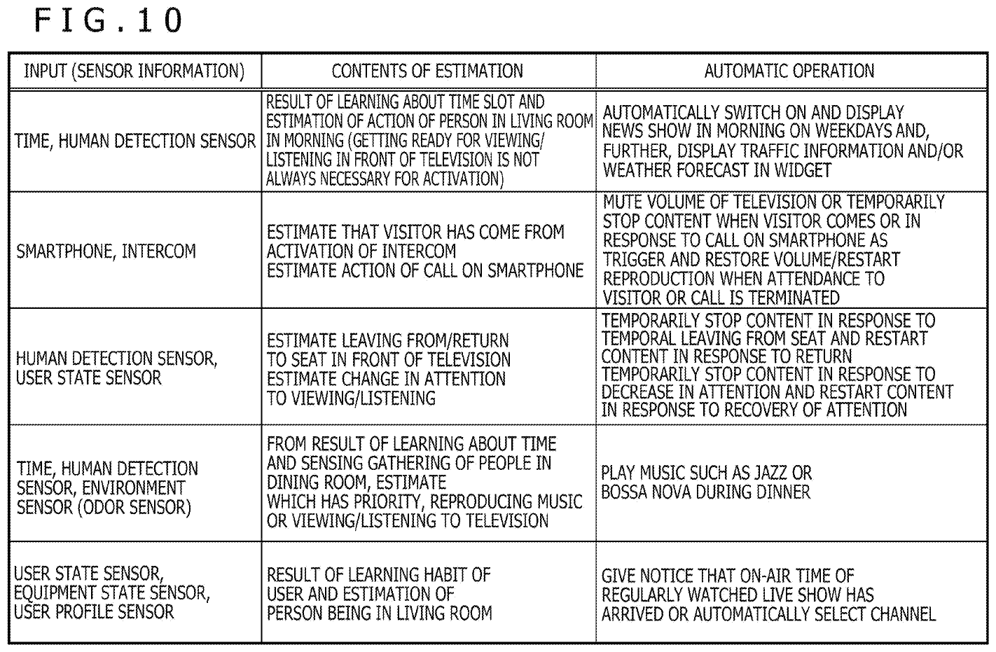

In FIG. 10, working examples of the automatic operation estimation neural network 500 are listed together.

The automatic operation estimation neural network 500 has learnt a correlation between a time slot and a television operation on the basis of time (clock) and/or sensor information from a human detection sensor or the like. The automatic operation estimation neural network 500 then outputs, in response to estimating an action of a person in a living room in the morning, an automatic operation of turning on the television reception apparatus 100 with a news show displayed. The automatic operation estimation neural network 500 may further output an automatic operation of causing traffic information and/or weather forecast to be displayed in a widget or the like on a display screen of the news show (getting ready for viewing/listening in front of the television is not always necessary for outputting the automatic operation). In contrast, the automatic operation estimation neural network 500 also outputs, in response to estimating that the user is going to work or going out or going to bed on the basis of time (clock) and/or sensor information from the human detection sensor or the like, an automatic operation of turning off the television reception apparatus 100.

Further, the automatic operation estimation neural network 500 has learnt a correlation between coming of a visitor or a calling action and volume or working for reproducing content on the basis of a working status of a smartphone or a home intercom. The automatic operation estimation neural network 500 then outputs, in response to estimating the start of attendance to a visitor or a phone call on the basis of inputted information, an automatic operation of muting the volume of the television reception apparatus 100 or temporarily stopping the reproduced content. The automatic operation estimation neural network 500 then outputs, in response to estimating that the visitor has gone or the phone call is terminated on the basis of inputted information, an automatic operation of restoring the muted volume or restarting the reproduction of the temporarily stopped content.

Further, the automatic operation estimation neural network 500 has learnt a correlation between a status of whether the user is seated in front of the television screen or is away from the seat or a focus level on a television program and working for reproducing content on the basis of sensor information from the human detection sensor and a user state sensor. The automatic operation estimation neural network 500 then outputs, on the basis of the sensor information, an automatic operation of temporarily stopping the content in response to the user being temporarily away from the seat and outputs an automatic operation of restarting reproduction of the temporarily stopped content in response to the user returning. Further, the automatic operation estimation neural network 500 outputs, on the basis of the sensor information, an automatic operation of temporarily stopping the content (or switching the television channel) in response to a decrease in the focus level of the user and outputs an automatic operation of restarting reproduction of the temporarily stopped content in response to recovery of the focus level of the user. For that matter, the automatic operation estimation neural network 500 may output an automatic operation of starting program recording or setting the timer for the next program recording, when the focus level of the user exceeds a predetermined level.

Further, the automatic operation estimation neural network 500 has learnt a correlation between viewing/listening to a television program and a priority of reproducing music during a meal on the basis of time and sensor information from the human detection sensor and an environment sensor (e.g., an odor sensor). The automatic operation estimation neural network 500 then outputs, in response to people gathering in the dining room and starting dinner on the basis of the sensor information, an automatic operation of stopping viewing/listening of the television and starting reproduction of music.

Further, the automatic operation estimation neural network 500 has learnt a correlation between a habit of the user and a television operation on the basis of sensor information from the user state sensor, an equipment state sensor, and a user profile sensor. The automatic operation estimation neural network 500 then outputs, in response to, for example, arrival of an on-air time of a live program regularly watched by the user, an automatic operation of notifying the user accordingly or automatically selecting the channel.

Further, the automatic operation estimation neural network 500 has learnt a correlation between a television-viewing/listening environment and a television operation on the basis of sensor information from the environment sensor. The automatic operation estimation neural network 500 then outputs, in response to the surroundings becoming noisy due to construction in the neighborhood or the like, an automatic operation of increasing the volume and outputs, in response to the silence coming back again, an automatic operation of restoring the volume. Alternatively, the automatic operation estimation neural network 500 outputs, in response to the room getting bright or natural light entering through a window, an automatic operation of increasing a luminance of the screen or the backlight, whereas outputting, in response to the room getting dark due to sunset, weather, or the like, an automatic operation of reducing the luminance of the screen or the backlight.

### D. Feedback to User on Automatic Operation of Equipment

As described in Section C above, the automatic operation of the television reception apparatus 100 being performed on the basis of the sensing result of the state of the user or the surrounding environment is convenient for the user, since an appropriate environment for viewing/listening to a television can be obtained without the necessity of performing an explicit action such as remote controller operation or voice input.

There is no problem as long as a correspondence relation between the state of the user or the surrounding environment and the automatically performed operation of the television reception apparatus 100 is clear to the user. For example, as for an operation such as the television reception apparatus 100 being turned on at the same time as the user comes in or out or the volume being lowered in response to the start of a phone call, the user is supposed to be able to easily understand why the television reception apparatus 100 is turned on or the volume is lowered.

In contrast, the correspondence relation between the state of the user or the surrounding environment, and the automatically performed operation of the television reception apparatus 100 is difficult for the user to understand in some cases. In such a case, the user is likely to misunderstand that the television reception apparatus 100 malfunctions or is broken. If the user arranges to have the television reception apparatus 100 repaired, disposed of, or replaced due to the misunderstanding, unnecessary costs will be spent. For that matter, as a result of learning, the automatic operation estimation neural network 500 starts an automatic operation of the television reception apparatus 100 on the basis of a cause or a reason different from before in some cases and, if so, it would be difficult for the user to understand why the automatic operation is performed.

Accordingly, in the present embodiment, when an automatic operation of the television reception apparatus 100 based on a sensing result is performed, user feedback is further performed to present a cause or a reason that such an automatic operation has been performed (why such an automatic operation has been performed). The present embodiment is characterized further in that such user feedback on an automatic operation of the television reception apparatus 100 is achieved by using the neural network, so that a cause or a reason for the automatic operation is estimated by artificial intelligence.

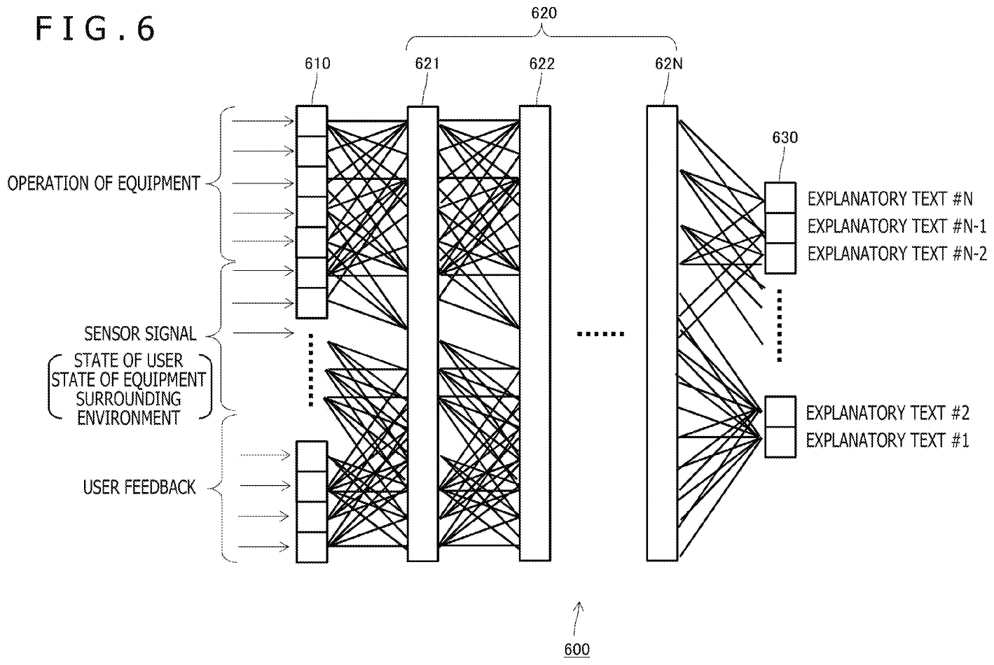

FIG. 6 illustrates a configuration example of a presentation estimation neural network 600 that presents a cause or a reason for an automatic operation. The presentation estimation neural network 600 includes an input layer 610 where an automatic operation on the television reception apparatus 100 and a sensor signal resulting from performing the automatic operation are to be inputted and an output layer 630 that outputs an explanatory text for explaining the user about a cause or a reason that the automatic operation has been performed. In the illustrated example, an intermediate layer 620 includes a plurality of intermediate layers 621, 622, . . . and the presentation estimation neural network 600 can perform DL. It should be noted that, in consideration of time-series information such as a moving image or audio being processed as a sensor signal, the intermediate layer 620 may have an RNN structure containing reflexive join.

Output from the automatic operation estimation neural network 500 illustrated in FIG. 5 is to be inputted to the input layer 610. Accordingly, the input layer 610 contains a plurality of input nodes associated with the respective output nodes each of which corresponds to an equipment operation in the output layer 530.

Also, the input layer 610 contains one or more input nodes that individually receive one or more sensor signals contained in the sensor group 400 illustrated in FIG. 4. The input layer 610 contains a moving image stream (or a still image is also acceptable) captured by the camera 411 as an input vector element. Basically, an image signal captured by the camera 411 is to be inputted to the input layer 610 while remaining as RAW data. Further, in a case where sensor signals from other sensors are also used to estimate a reason that the automatic operation has been performed in addition to an image captured by the camera 411, a configuration where input nodes corresponding to the respective sensor signals are additionally arranged in the input layer 610 is employed. Further, a convolutional neural network (CNN) may be used for input of an image signal or the like, thereby performing condensation processing of a feature point.

Further, the output layer 630 outputs sensor information acquired by the sensor group 400 and an explanatory text that is appropriate (seems to be reasonable) to an operation of the television reception apparatus 100 outputted from the automatic operation estimation neural network 500 (described above) in response to the sensor information. The explanatory text is assumed to be a text likely to able to make the user understood why the automatic operation of the television reception apparatus 100 has been performed on the basis of the state of the user or the surrounding environment estimated on the basis of the sensor information. Accordingly, in the output layer 630, output nodes corresponding to respective pieces of text data of these explanatory texts are arranged. Then, the output node corresponding to the explanatory text that seems to be reasonable to the sensor information and the operation of the television reception apparatus 100 inputted to the input layer 610 fires.

During a learning process of the presentation estimation neural network 600, a correlation between the sensor information and automatic operation, and the explanatory text is learnt by inputting a huge number of combinations of the images of the user or other sensor signals and automatic operations on the television reception apparatus 100 and explanatory texts indicating reasons for performing the automatic operations to the presentation estimation neural network 600 and updating respective weight coefficients of the nodes in the intermediate layer 620, which includes the plurality of layers, such that the strength of connection between the images of the user or other sensor signals and the output nodes for the explanatory texts that seem to be reasonable with respect to the automatic operations of the television reception apparatus 100 increases. Then, during an identification (explanation of the automatic operation) process of the presentation estimation neural network 600, the presentation estimation neural network 600 highly accurately outputs, in response to input of the sensor information acquired by the sensor group 400 and the automatic operation performed on the television reception apparatus 100, the explanatory text that seems to be reasonable for making the user understand a cause or a reason that the automatic operation has been performed.

The presentation estimation neural network 600 as illustrated in FIG. 6 is implemented in, for example, the main control section 201. Accordingly, a processor dedicated for a neural network may be included in the main control section 201. Alternatively, the presentation estimation neural network 600 may be provided by a cloud on the Internet; however, in order to perform an automatic operation of the television reception apparatus 100 in real time according to the action of the user, the state of the user, or the surrounding environment, it is preferable that the presentation estimation neural network 600 be provided in the television reception apparatus 100.

For example, the television reception apparatus 100 incorporated with the presentation estimation neural network 600 having completed learning by using an expert teaching database is shipped. The presentation estimation neural network 600 may continuously learn by an algorithm such as back propagation (inverse error propagation). Alternatively, the presentation estimation neural network 600 in the television reception apparatus 100 installed at each home can be updated with a result of learning performed on the basis of data collected from a huge number of users on a cloud side on the Internet. Description will be made on this point later.

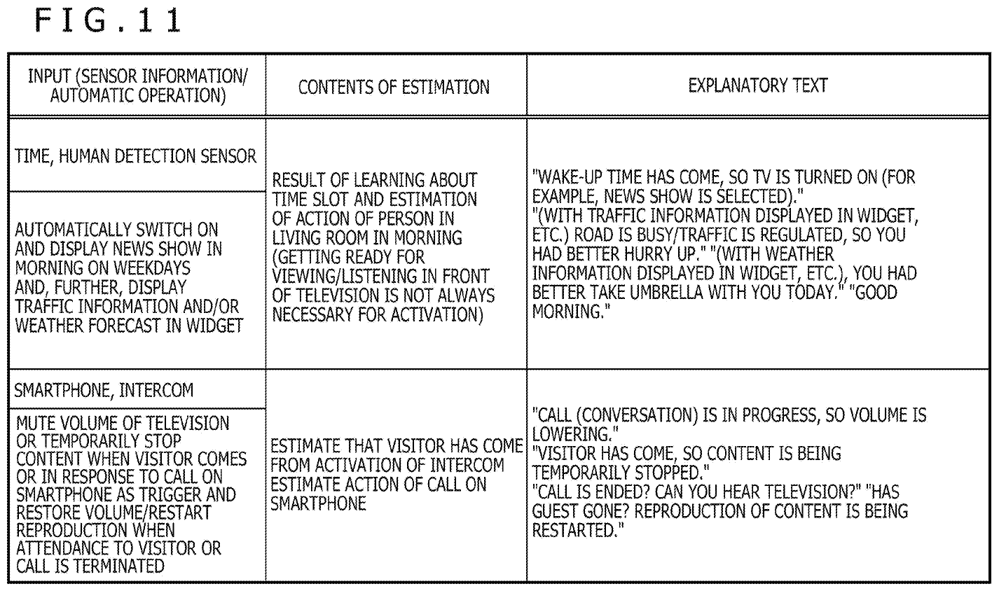

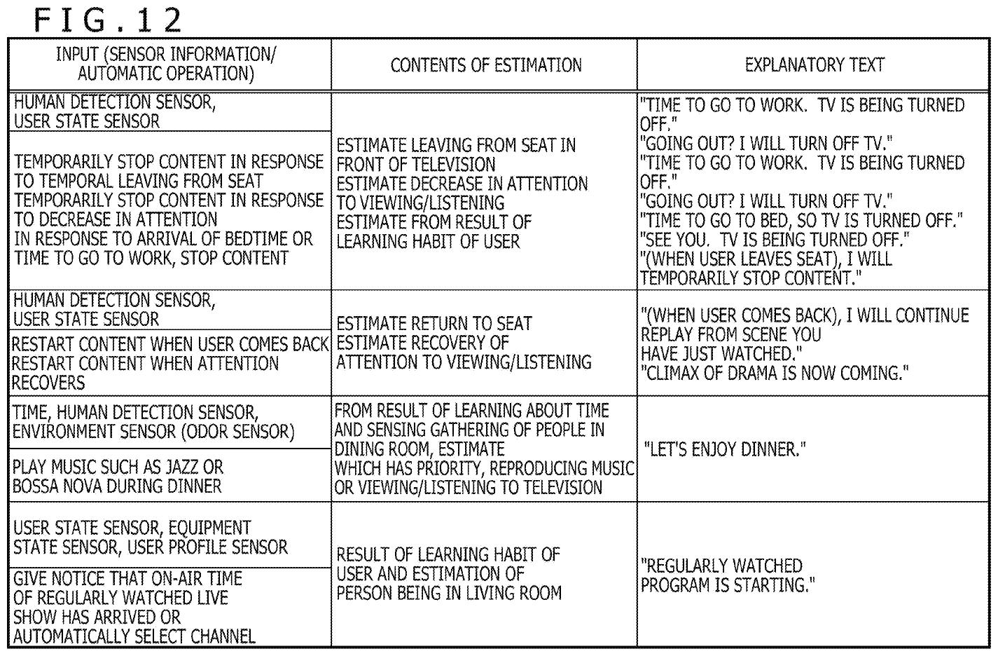

In FIG. 11 and FIG. 12, working examples of the presentation estimation neural network 600 are listed together.

In response to time (clock) and/or sensor information from a human detection sensor or the like and an automatic operation of automatically turning on the television reception apparatus 100 with a news show displayed in the morning on weekdays (further, displaying traffic information and/or weather forecast in a widget or the like) being performed, the presentation estimation neural network 600 estimates that a reason or a cause for the automatic operation includes a result of learning a time slot and an action of a person in the living room in the morning. The presentation estimation neural network 600 thus outputs, in response to the automatic operation based on the time slot and the action of the person in the living room in the morning being performed on the television reception apparatus 100, explanatory texts as given below.

“Wake-up time has come, so TV is turned on (for example, a news show is selected).”
“(With traffic information displayed in a widget etc.) the road is busy/the traffic is regulated, so you had better hurry up.”
“(With weather information displayed in a widget etc.), you had better take an umbrella with you today.”
“Good morning.”

Further, in response to an automatic operation of muting the volume of the television or temporarily stopping reproduced content being performed as triggered by a working status of a smartphone or a home intercom and coming of a visitor or a call on the smartphone, the presentation estimation neural network 600 estimates that a reason or a cause for the automatic operation is the coming of the visitor or the start of the call on the phone. The presentation estimation neural network 600 thus outputs, in response to the automatic operation based on the coming of the visitor or the call on the phone being performed on the television reception apparatus 100, explanatory texts as given below.

“A call (conversation) is in progress, so the volume is lowering.”
“A visitor has come, so the content is being temporarily stopped.”

Afterwards, when estimating that an automatic operation of restoring the muted volume or restarting the reproduction of the temporarily stopped content is performed in response to attendance to the visitor or the call on the phone being terminated, the presentation estimation neural network 600 outputs explanatory texts as given below.

“The call is ended? Can you hear the television?”
“Has the guest gone? Reproduction of the content is being restarted.”

Further, in response to an automatic operation of temporarily stopping reproduction of content being performed in response to sensor information from the human detection sensor, a user state sensor, etc. and the user temporarily leaving from the seat, the focus of the user decreasing, or bedtime or time to go to work arriving, the presentation estimation neural network 600 estimates that a reason or a cause for the automatic operation is the presence/absence of the user or the state of the user. The presentation estimation neural network 600 thus outputs, in response to the automatic operation based on the presence/absence of the user or the state of the user being performed on the television reception apparatus 100, explanatory texts as given below.

“Time to go to work. TV is being turned off.”
“Going out? I will turn off TV.”
“Time to go to work. TV is being turned off.”
“Going out? I will turn off TV.”
“Time to go to bed, so TV is turned off.”
“See you. TV is being turned off.”
“The show is boring, isn't it? Shall I turn off TV?”
“You are watching TV for a long period of time and may be tired. Shall I turn it off?”
“The show is boring, isn't it? Shall I switch the channel?”
“The show is boring, isn't it? Here is an interesting DVD.”
“An interesting video is distributed. Do you want to watch it?”

Further, in response to an automatic operation of restarting reproduction of the temporarily stopped content being performed in response to sensor information from the human detection sensor, the user state sensor, etc. and the user who has left the seat coming back or the focus of the user recovering, the presentation estimation neural network 600 estimates that a reason or a cause for the automatic operation is the presence/absence of the user or the state of the user. The presentation estimation neural network 600 thus outputs, in response to the automatic operation based on the presence/absence of the user or the state of the user being performed on the television reception apparatus 100, explanatory texts as given below.

“(When the user comes back), I will continue replay from the scene you have just watched.”
“The climax of the drama is now coming.”
“The show is interesting, isn't it? Let's record (set a timer for recording) it.”

Further, in response to time or sensor information from the human detection sensor, an environment sensor, etc. and an automatic operation of starting reproduction of music such as jazz or bossa nova during dinner being performed, the presentation estimation neural network 600 estimates that a reason or a cause for the automatic operation is that reproducing music has a priority over viewing/listening to television by virtue of a result of learning about time and sensing gathering of people in the dining room being sensed. In response to the automatic operation based on the result of learning about time and sensing the gathering of people in the dining room being performed on the television reception apparatus 100, the presentation estimation neural network 600 outputs an explanatory text as given below.

“Let's enjoy dinner”

Further, in response to sensor information from the user state sensor, the equipment state sensor, the user profile sensor, etc. and an automatic operation of giving a notification of arrival of the on-air time of a regularly watched live show or automatically selecting the channel being performed, the presentation estimation neural network 600 estimates that a reason or a cause for the automatic operation includes a result of learning a habit of the user and the presence of a person in the living room. Thus, in response to the automatic operation based on the arrival of the on-air time of the regularly watched live show being performed on the television reception apparatus 100, the presentation estimation neural network 600 outputs an explanatory text as given below.

“The regularly watched program is starting.”

Further, in response to sensor information from the environment sensor and an automatic operation of increasing the volume in response to the surroundings becoming noisy due to construction in the neighborhood or the like being performed, the presentation estimation neural network 600 estimates that a reason or a cause for the automatic operation is an ambient sound. The presentation estimation neural network 600 thus outputs, in response to the automatic operation of increasing the volume on the basis of the ambient sound being performed on the television reception apparatus 100, an explanatory text as given below.

“Construction is in progress, so it is noisy, isn't it? Can you hear the television?”

Afterwards, when estimating that the construction is ended with the silence coming back and an automatic operation of restoring the volume having been increased to the original volume is performed, the presentation estimation neural network 600 outputs an explanatory text as given below.

“Construction is ended, and it becomes quiet again, isn't it? The volume is being lowered.”

Further, in response to sensor information from the environment sensor and an automatic operation of increasing the luminance of the screen or the backlight in response to sunlight entering the room or reducing the luminance of the screen or the backlight in response to the room getting dark being performed, the presentation estimation neural network 600 estimates a reason or a cause for the automatic operation is the light intensity in the room. The presentation estimation neural network 600 thus outputs, in response to the automatic operation of adjusting the luminance of the screen and the backlight on the basis of the light intensity of the room being performed on the television reception apparatus 100, explanatory texts as given below.

“Sunlight is entering, so the screen gets brightened.”
“It has got dark, so the screen gets dimmed.”

There are a variety of manners to feed back the explanatory texts as described above to the user. For example, an OSD (On Screen Display) including a text of the explanatory text may be displayed on the screen of the display section 219. Alternatively, in addition to displaying the text (or instead of displaying the text), a voice guidance may be synthesized by the audio synthesis section 220 and outputted as voice from the audio output section 221. Alternatively, the feedback to the user may be performed with use of a voice agent such as an AI speaker. In any manner to explain, it is favorable to avoid giving an excessive explanation to pretend to be casual.

Almost all the above-listed explanatory texts relate to a case where the cause or reason that the automatic operation of the television reception apparatus 100 has been performed is clear. The user will be able to easily understand the state of the user or the surrounding environment that has caused the automatic operation by seeing and/or hearing the explanatory text. In contrast, it is assumable that the user cannot understand the reason for the automatic operation due to pieces of inappropriate content of the explanatory text or the user cannot accept the reason for the automatic operation due to inappropriateness of the performed automatic operation itself. For that matter, as a result of the automatic operation estimation neural network 500 performing learning, the automatic operation of the television reception apparatus 100 is started on the basis of a cause or a reason different from before in some cases and, accordingly, it is assumable that the user is unlikely to understand why the automatic operation has been performed.

Accordingly, the presentation estimation neural network 600 of the present embodiment has a configuration to also learn explanatory texts on the basis of reaction or understanding level of the user relative to an outputted explanatory text. The learning here can also refer to processing corresponding to customizing the presentation estimation neural network 600 to be adapted to characteristics of individual users.

The input layer 610 further contains an input node that receives feedback from the user, that is, the reaction or the understanding level of the user who has seen or heard the explanatory text, in addition to the input nodes where sensor signals are to be inputted and the input nodes associated with the respective output nodes each of which corresponds to an equipment operation, in the output layer 530.

In a case where the reaction or the understanding level of the user is to be inputted in text data such as “I cannot really understand it,” “What does it mean?” and “In other words?” it is only necessary to contain input nodes corresponding to the respective pieces of text data in the input layer 610. For example, feedback from the user can be acquired by directly making an inquiry, such as “can you understand?” to the user about the understanding level with use of a conversation function, immediately after the explanatory text regarding the equipment operation is presented to the user. Alternatively, in a case where the understanding level of the user is expressed using discrete level values, it is only necessary to contain input nodes corresponding to the number of levels in the input layer 610. Alternatively, the user feedback on the presented explanatory text may be expressed as either OK (good) or NG (not good) for the presented explanatory text. In this case, it is only necessary to contain an input node corresponding to each of OK and NG in the input layer 610. The user may express whether the explanatory text is OK or NG to the television reception apparatus 100 using, for example, a remote controller or a smartphone.

Then, a correlation between the sensor information and the automatic operation, and the explanatory text is continuously learnt by updating the weight coefficients of the nodes in the intermediate layer 620 which includes the plurality of layers, such that feedback indicating that the presented explanatory text can be understood or is accepted, such as “I can understand it well” or “thank you,” can be obtained from the user. This makes it possible to customize the presentation estimation neural network 600 to individual users.

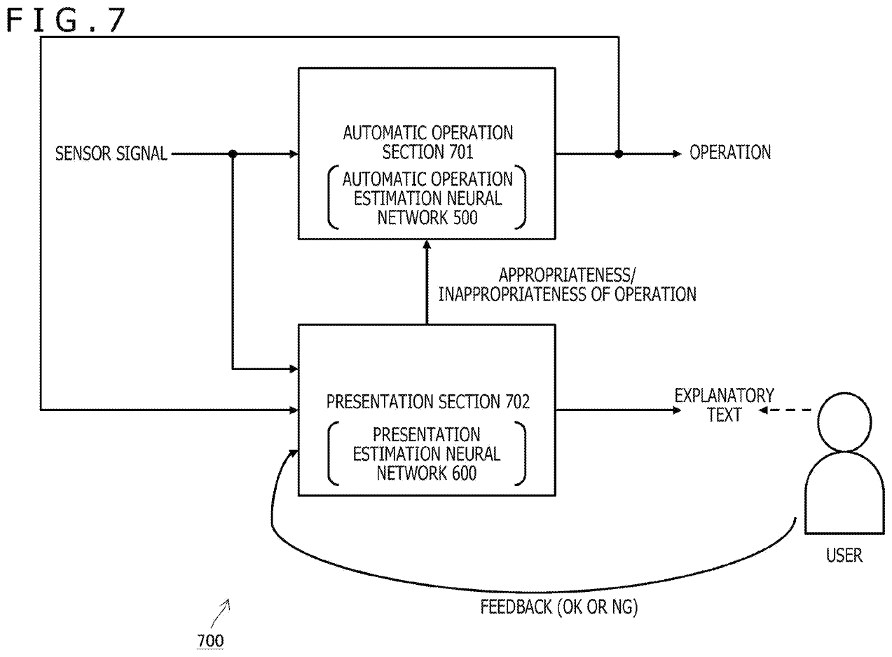

FIG. 7 schematically illustrates a configuration example of an automatic operation and presentation system 700 that performs an automatic operation of the television reception apparatus 100 by sensing and that explains to the user about the automatic operation.

The illustrated automatic operation and presentation system 700 includes a combination of an automatic operation section 701 provided by the automatic operation estimation neural network 500 (see FIG. 5) and a presentation section 702 provided by the presentation estimation neural network 600 (see FIG. 6). The automatic operation estimation neural network 500 and the presentation estimation neural network 600 are each the same as already described and, accordingly, a detailed description thereof is omitted here.

In response to a sensor signal (including an image captured by the camera 411) being inputted from the sensor group 400 and conditions for performing a specific operation on the television reception apparatus 100 being detected, the automatic operation section 701 outputs that operation.

The main control section 201 controls the working of the television reception apparatus 100, thereby causing the operation outputted from the automatic operation section 701 to be automatically performed.

The same sensor signal as in the automatic operation section 701 is also inputted to the presentation section 702. Further, an operation to be performed on the television reception apparatus 100 by the automatic operation section 701 in response to the sensor signal is also inputted to the presentation section 702.

Then, the presentation section 702 detects, from sensor information acquired by the sensor group 400, the conditions having caused the automatic operation to be performed on the television reception apparatus 100 and outputs an explanatory text that seems to be reasonable for making the user understand the conditions.

Further, user feedback indicating whether or not the user can understand the outputted explanatory text (for example, whether the explanatory text is either OK or NG) is inputted to the presentation section 702. Then, the correlation between the sensor information and the automatic operation, and the explanatory text is further learnt by updating the weight coefficients of the nodes of the intermediate layer 620 including the plurality of layers. This makes it possible to customize the presentation estimation neural network 600 to the user such that feedback indicating that the explanatory text is understood or accepted can be obtained from the user.

Further, there is prepared a mechanism that causes a notification of appropriateness/inappropriateness of an automatic operation to be given from the presentation section 702 to the automatic operation section 701. In a case where the feedback obtained from the user indicates that the automatic operation performed by the automatic operation section 701 is inappropriate, a notification of the inappropriate automatic operation is given from the notified presentation section 702 to the automatic operation section 701. On an automatic operation section 701 side, the correlation between the sensor information and the automatic operation is further learnt by updating the weight coefficients in the nodes of the intermediate layer 520 including the plurality of layers. This makes it possible to customize the automatic operation estimation neural network 500 to the user such that an automatic operation acceptable to the user is performed.

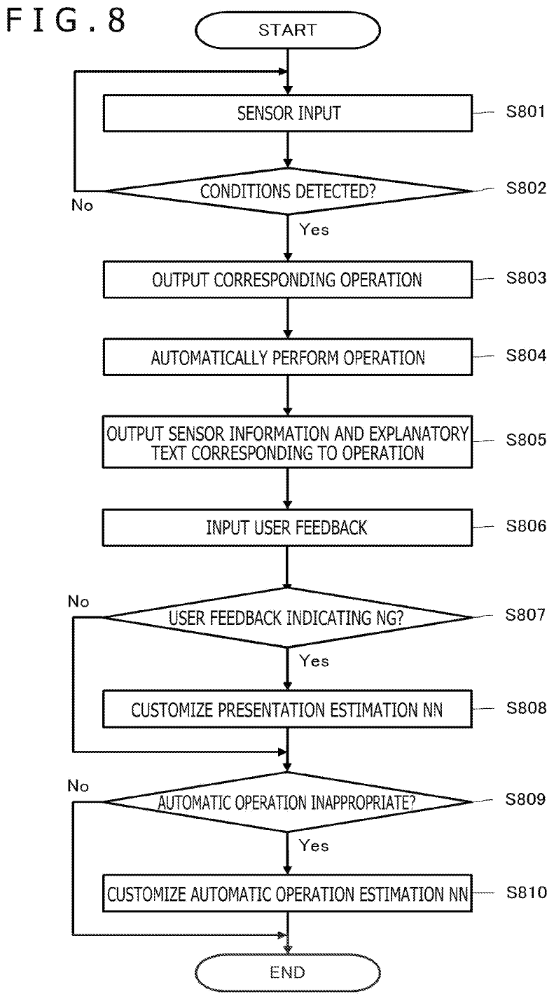

FIG. 8 illustrates a procedure of processing that is to be performed by the automatic operation and presentation system 700 in a flowchart form.

Sensor signals (including an image captured by the camera 411) are constantly inputted to the automatic operation section 701 and the presentation section 702 from the sensor group 400 (Step S801). Then, in response to conditions for performing a specific operation on the television reception apparatus 100 being detected (Yes in Step S802), the automatic operation section 701 outputs the operation corresponding to the conditions to each of the main control section 201 and the presentation section 702 (Step S803).

The main control section 201 controls the working of the television reception apparatus 100, thereby causing the operation outputted from the automatic operation section 701 to be automatically performed (Step S804).

Subsequently, the presentation section 702 detects, from the sensor information inputted in Step S801 and the operation inputted in Step S803 (automatically operated on the television reception apparatus 100), conditions causing the automatic operation in Step S804 to be performed on the television reception apparatus 100 and outputs an explanatory text that seems to be reasonable for making the user understand the conditions (Step S805).

In Step S805, there are a variety of manners to output the explanatory text. For example, an OSD including a text including the explanatory text may be displayed on the screen of the display section 219. Alternatively, in addition to displaying the text (or instead of displaying the text), a voice guidance may be synthesized by the audio synthesis section 220 and outputted as voice from the audio output section 221. Alternatively, the feedback to the user may be performed with use of a voice agent such as an AI speaker.

Further, user feedback indicating whether or not the user understands the outputted explanatory text is inputted to the presentation section 702 (Step 806).

Here, in a case where no feedback indicating that the explanatory text outputted in Step S805 is understood or accepted is obtained from the user (for example, in a case where the user replies NG) (Yes in Step S807), the correlation between the sensor information and the automatic operation, and the explanatory text is further learnt by updating, in the presentation estimation neural network 600 of the presentation section 702, the weight coefficients of the nodes in the intermediate layer 620, thereby customizing the presentation estimation neural network 600 to the user such that feedback indicating the explanatory text for the automatic operation is understood or accepted can be obtained from the user (Step S808).

Further, in a case where the user cannot accept the reason for the automatic operation due to inappropriateness of the automatic operation performed in Step S804 (for example, in a case where the user replies NG) (Yes in Step S809), the correlation between the sensor information and the automatic operation is further learnt by updating, in the automatic operation estimation neural network 500 of the automatic operation section 701, the weight coefficients of the nodes in the intermediate layer 520, thereby customizing the automatic operation estimation neural network 500 to the user so that feedback indicating the explanatory text for the automatic operation is understood or accepted can be obtained from the user (Step S810). In contrast, in a case where the user does not reply NG and the automatic operation is appropriate (No in Step S807 and No in S809), this processing is terminated directly.

### E. Update and Customization of Neural Network

Description is made hereinbefore on the automatic operation estimation neural network 500 which is usable during the process to estimate the automatic operation of the television reception apparatus 100 by artificial intelligence on the basis of the sensor information, and the presentation estimation neural network 600 which is usable during the process to estimate the reason that the automatic operation has been performed on the television reception apparatus 100.

These neural networks are workable in an apparatus directly operable by the user, i.e., the television reception apparatus 100 installed at each home or in a working environment (hereinafter, also referred to as “local environment”) such as home where the apparatus is installed. One of effects of causing the neural networks to work as functions of artificial intelligence in a local environment is, for example, that an algorithm such as back propagation (inverse error propagation) is applied to these neural networks, enabling learning by using feedback from the user or the like as teaching data to be easily achieved in real time. The feedback from the user, which is, for example, evaluation of the explanatory text presented by the presentation estimation neural network 600 from the user, may be as simple as OK (good) or NG (not good). The user feedback is to be inputted to the television reception apparatus 100 via, for example, the operation input section 222, a remote controller, a voice agent, which is an embodiment of artificial intelligence, a cooperated smartphone, or the like. Accordingly, another effect of causing the neural networks to work as these functions of artificial intelligence in a local environment is that the neural networks can be customized or personalized to a specific user by virtue of learning using user feedback.

Meanwhile, there is another possible method in which, in one or more server apparatuses (hereinafter, also referred to simply as a “cloud”) that are workable on a cloud, that is, a cluster of server apparatuses on the Internet, data is collected from a huge number of users and learning of the neural networks as the functions of artificial intelligence is repeated, and a result of the learning is used to update the neural networks in the television reception apparatus 100 at each home. One of effects of updating the neural networks that fulfill the functions of artificial intelligence on the cloud is that a neural network with a higher accuracy can be configured by virtue of learning using a large amount of data.

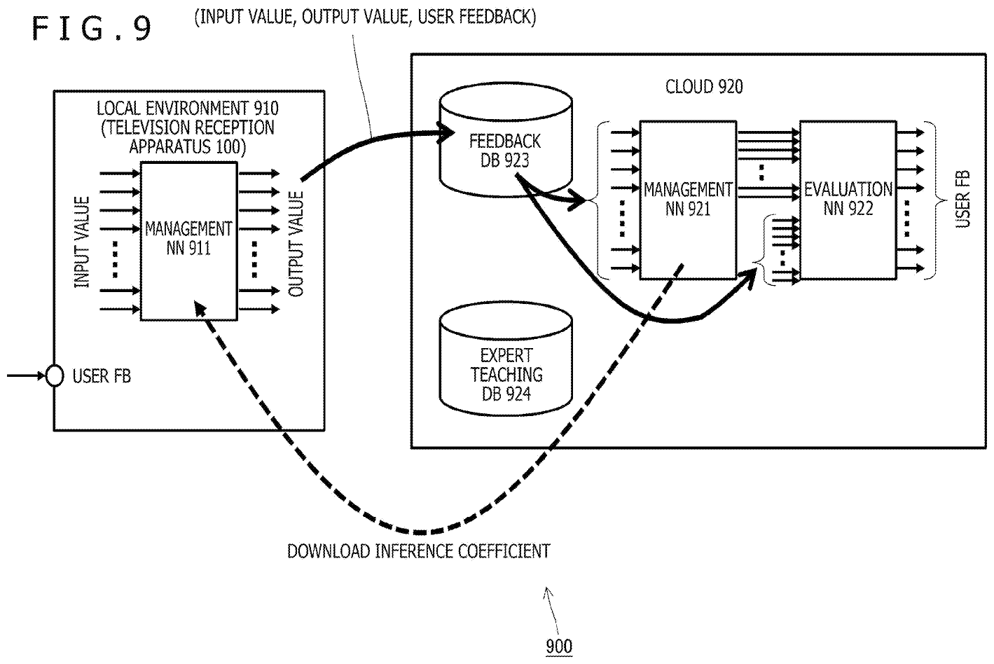

FIG. 9 schematically illustrates a configuration example of an artificial intelligence system 900 using a cloud. The artificial intelligence system 900 using a cloud as illustrated includes a local environment 910 and a cloud 920.

The local environment 910 corresponds to a working environment (home) where the television reception apparatus 100 is installed or the television reception apparatus 100 installed at home. FIG. 9 illustrates the single local environment 910 for simplicity; however, it is assumed that a huge number of local environments are actually connected to the single cloud 920. Further, in the present embodiment, the local environment 910 is exemplified mainly by the television reception apparatus 100 or a working environment such as home where the television reception apparatus 100 is workable; however, the local environment 910 only needs to be any apparatus directly operable by a user, such as a smartphone or a wearable device, or an environment where the device is workable (including public facilities such as a station, a bus stop, an airport, and a shopping center and work equipment in a factory, a workplace, and the like).

As described above, the automatic operation estimation neural network 500 and the presentation estimation neural network 600 are provided as artificial intelligence in the television reception apparatus 100. These neural networks installed in the television reception apparatus 100 and contributing to actual use are collectively referred to as a management neural network 911 here. It is assumed that the management neural network 911 has learnt previously by using an expert teaching database including a huge amount of sample data.

Meanwhile, the cloud 920 is provided with an artificial intelligence server (described above) (including one or more server apparatuses) that provides an artificial intelligence function. In the artificial intelligence server, a management neural network 921 and an evaluation neural network 922 that evaluates the management neural network 921 are arranged. It is assumed that the management neural network 921, which is the same in configuration as the management neural network 911 provided in the local environment 910, has learnt previously by using an expert teaching database including a huge amount of sample data. Further, the evaluation neural network 922 is a neural network usable for evaluating a learning status of the management neural network 921.

On a local environment 910 side, the management neural network 911 receives input of sensor information such as an image captured by the camera 411 and a user profile and outputs an automatic operation adapted to the user profile (in particular, in a case where the management neural network 911 is the automatic operation estimation neural network 500), or receives input of sensor information, an automatic operation, and a user profile and outputs an explanatory text for the automatic operation adapted to the user profile (in particular, in a case where the management neural network 911 is the presentation estimation neural network 600). Here, for simplicity, the input to the management neural network 911 will be referred to simply as an “input value” and the output from the management neural network 912 will be referred to simply as an “output value.”

The user of the local environment 910 (for example, a viewer/listener of the television reception apparatus 100) evaluates the output value from the management neural network 911 and feeds back an evaluation result to the television reception apparatus 100 via, for example, the operation input section 222, a remote controller, a voice agent, a cooperated smartphone, or the like. Here, for simplicity of explanation, it is assumed that the user feedback is either OK (0) or NG (1).

Feedback data including a combination of the input value and output value of the management neural network 911 and the user feedback is sent to the cloud 920 from the local environment 910 to the cloud 920. In the cloud 920, the feedback data sent from a huge number of local environments is increasingly accumulated in a feedback database 923. In the feedback database 923, a huge amount of feedback data indicating a correspondence relation between the input value and output value of the management neural network 911 and the user is accumulated.

Further, the cloud 920 is capable of holding or using an expert teaching database 924 including a huge amount of sample data used for the previous learning of the management neural network 911. Each piece of the data is teaching data indicating a correspondence relation between the sensor information and the user profile and the output value from the management neural network 911 (or 921).

When the feedback data is taken out of the feedback database 923, an input value (for example, a combination of sensor information and user profile) contained in the feedback data is inputted to the management neural network 921. Further, the output value from the management neural network 921 and the input value (for example, a combination of sensor information and user profile) contained in the corresponding feedback data are inputted to the evaluation neural network 922, and the evaluation neural network 922 outputs user feedback.

In the cloud 920, the learning of the evaluation neural network 922 as a first step and the learning of the management neural network 921 as a second step are alternately performed.

The evaluation neural network 922 is a network that learns a correspondence relation between an input value to the management neural network 921 and user feedback to output from the management neural network 921. Thus, in the first step, the evaluation neural network 922 receives input of an output value from the management neural network 921 and user feedback contained in the corresponding feedback data, learning such that user feedback outputted from itself on the output value from the management neural network 921 matches actual user feedback on the output value from the management neural network 921. As a result, the evaluation neural network 922 is caused to gradually learn such that the evaluation neural network 922 outputs user feedback (OK or NG) similar to that from the actual user on the output of the management neural network 921.

In the subsequent second step, while the evaluation neural network 922 is fixed, the management neural network 921 is now caused to learn. As described above, when feedback data is taken out of the feedback database 923, an input value contained in the feedback data is inputted to the management neural network 921, whereas an output value from the management neural network 921 and data regarding user feedback contained in the corresponding feedback data are inputted to the evaluation neural network 922. The evaluation neural network 922 outputs user feedback equal to that of the actual user.

At this time, the management neural network 921 applies an evaluation function (for example, a loss function) to output from the output layer in the neural network and performs learning by back propagation such that the resulting value becomes minimized. For example, in a case where the user feedback is used as the teaching data, the management neural network 921 learns such that output from the evaluation neural network 922 to all the input values becomes OK (0). By virtue of performing such learning, the management neural network 921 becomes able to output, in response to any input value (sensor information, user profile, or the like), an output value (an automatic operation of the television reception apparatus 100 or an explanatory text for the automatic operation) on which the user provides OK as feedback.

Alternatively, for learning of the management neural network 921, the expert teaching database 924 may be used as the teaching data. Alternatively, two or more types of teaching data such as the user feedback and the expert teaching database 924 may be used for learning. In this case, the learning of the management neural network 921 may be performed such that a loss function calculated for each teaching data is added by weighting to be minimized.

The learning of the evaluation neural network 922 as the first step and the learning of the management neural network 921 as the second step as described above are alternately performed with the accuracy of the management neural network 921 gradually improved. Then, an inference coefficient in the management neural network 921 improved in accuracy through learning is provided to the management neural network 911 in the local environment 910, enabling the user to enjoy the management neural network 911 having further progressed in learning.

For example, a bit stream of the inference coefficient of the management neural network 911 may be compressed and downloaded from the cloud 920 to a local environment. In a case where the bit stream is still large in size even when compressed, with the inference coefficient divided on a layer-basis or an area-basis, the compressed bit stream may be divided and downloaded for a plurality of times.

### INDUSTRIAL APPLICABILITY

The technology disclosed herein is described above in detail with reference to a specific embodiment. However, it is obvious that those skilled in the art could achieve improvement or replacement of the embodiment without departing from the scope of the technology disclosed herein.

The description is made herein mainly on the embodiment where the technology disclosed herein is applied to a television receiver; however, the scope of the technology disclosed herein is not limited thereto. The technology disclosed herein is likewise applicable even to a display-equipped content acquirement apparatus or reproduction apparatus or a display apparatus having a function to acquire or reproduce a variety of types of content and that acquires a variety of reproduction content, such as a video and audio, by a broadcast wave or by streaming or downloading through the Internet to present the pieces of content to a user.

In short, the technology disclosed herein is described merely by way of example and the contents of the description should not be interpreted as being limiting. In order to determine the scope of the technology disclosed herein, the scope of claims should be taken into consideration.

It should be noted that the technology disclosed herein can also have the following configurations.

(1)

An artificial intelligence information processing apparatus including:

a control section configured to estimate an operation of equipment by artificial intelligence on the basis of sensor information and control the operation; and

a presentation section configured to estimate a reason that the control section has performed the operation of the equipment by the artificial intelligence on the basis of the sensor information and present the reason.

(2)

The artificial intelligence information processing apparatus according to (1), in which

as estimating the operation by the artificial intelligence, the presentation section is configured to estimate the reason that the operation of the equipment has been performed by using a first neural network that has learnt a correlation between the sensor information and the operation of the equipment and the reason that the operation of the equipment has been performed.

(3)

The artificial intelligence information processing apparatus according to (2), in which

as estimating the operation by the artificial intelligence, the control section is configured to estimate the operation of the equipment responsive to the sensor information by using a second neural network that has learnt a correlation between the sensor information and the operation of the equipment.

(4)

The artificial intelligence information processing apparatus according to (2) or (3), in which

the first neural network is configured to receive input of feedback from a user on the reason, thereby further learning the correlation between the sensor information and the operation of the equipment and the reason that the operation of the equipment has been performed.

(5)

The artificial intelligence information processing apparatus according to any one of (1) to (4), in which

the equipment includes a display apparatus.

(6)

The artificial intelligence information processing apparatus according to any one of (1) to (5), in which

the equipment includes a content reproduction apparatus.

(7)

The artificial intelligence information processing apparatus according to any one of (1) to (6), in which

the equipment includes a content acquirement apparatus.

(8)

The artificial intelligence information processing apparatus according to any one of (1) to (7), in which

the equipment includes a television reception apparatus.

(9)

An artificial intelligence information processing method including:

a control step of controlling an operation of equipment on the basis of sensor information; and

a presentation step of presenting a reason that the control section has performed the operation of the equipment on the basis of the sensor information.

(10)

The artificial intelligence information processing method according to (9), in which

the presentation step includes, as estimating the operation by artificial intelligence, estimating the reason that the operation of the equipment has been performed by using a first neural network that has learnt a correlation between the sensor information and the operation of the equipment and the reason that the operation of the equipment has been performed.

(11)

The artificial intelligence information processing method according to (10), in which

the control step includes, as estimating the operation by the artificial intelligence, estimating the operation of the equipment responsive to the sensor information by using a second neural network that has learnt a correlation between the sensor information and the operation of the equipment.

(12)

An artificial-intelligence-function-equipped display apparatus equipped with an artificial intelligence function and configured to display a video, the artificial-intelligence-function-equipped display apparatus including:

a display section;

an acquirement section configured to acquire sensor information;

a control section configured to estimate an operation of the artificial-intelligence-function-equipped display apparatus by artificial intelligence on the basis of the sensor information and control the operation; and

a presentation section configured to estimate a reason that the control section has performed the operation of the artificial-intelligence-function-equipped display apparatus by the artificial intelligence on the basis of the sensor information and cause the display section to present the reason.

### REFERENCE SIGNS LIST

100: Television reception apparatus, 201: Main control section, 202: Bus
203: Storage section, 204: Communication interface (IF) section
205: Expansion interface (IF) section
206: Tuner/demodulation section, 207: Demultiplexer
208: Video decoder, 209: Audio decoder
210: Superimposed-text decoder, 211: Subtitle decoder
212: Subtitle synthesis section, 213: Data decoder, 214: Cache section
215: Application (AP) control section, 216: Browser section
217: Sound source section, 218: Video synthesis section, 219: Display section
220: Audio synthesis section, 221: Audio output section, 222: Operation input section
400: Sensor group, 410: Camera section, 411 to 413: Camera
420: User state sensor section, 430: Environment sensor section
440: Equipment state sensor section, 450: User profile sensor section
500: Automatic operation estimation neural network, 510: Input layer
520: Intermediate layer, 530: Output layer
600: Presentation estimation neural network, 610: Input layer
620: Intermediate layer, 630: Output layer
700: Automatic operation and presentation system
701: Automatic operation section, 702: Presentation section
900: Artificial intelligence system using cloud
910: Local environment, 911: Management neural network
920: Cloud, 921: Management neural network
922: Evaluation neural network
923: Feedback database
924: Expert teaching database

1. An artificial intelligence information processing apparatus comprising:
a control section configured to estimate an operation of equipment by artificial intelligence on a basis of sensor information and control the operation; and
a presentation section configured to estimate a reason that the control section has performed the operation of the equipment by the artificial intelligence on the basis of the sensor information and present the reason.

2. The artificial intelligence information processing apparatus according to claim 1, wherein
as estimating the operation by the artificial intelligence, the presentation section is configured to estimate the reason that the operation of the equipment has been performed by using a first neural network that has learnt a correlation between the sensor information and the operation of the equipment and the reason that the operation of the equipment has been performed.

3. The artificial intelligence information processing apparatus according to claim 2, wherein
as estimating the operation by the artificial intelligence, the control section is configured to estimate the operation of the equipment responsive to the sensor information by using a second neural network that has learnt a correlation between the sensor information and the operation of the equipment.

4. The artificial intelligence information processing apparatus according to claim 2, wherein
the first neural network is configured to receive input of feedback from a user on the reason, thereby further learning the correlation between the sensor information and the operation of the equipment and the reason that the operation of the equipment has been performed.

5. The artificial intelligence information processing apparatus according to claim 1, wherein
the equipment includes a display apparatus.

6. The artificial intelligence information processing apparatus according to claim 1, wherein
the equipment includes a content reproduction apparatus.

7. The artificial intelligence information processing apparatus according to claim 1, wherein
the equipment includes a content acquirement apparatus.

8. The artificial intelligence information processing apparatus according to claim 1, wherein
the equipment includes a television reception apparatus.

9. An artificial intelligence information processing method comprising:
a control step of estimating and controlling an operation of equipment by artificial intelligence on a basis of sensor information; and
a presentation step of estimating and presenting a reason that the control section has performed the operation of the equipment by the artificial intelligence on the basis of the sensor information.

10. An artificial-intelligence-function-equipped display apparatus equipped with an artificial intelligence function and configured to display a video, the artificial-intelligence-function-equipped display apparatus comprising:
a display section;
an acquirement section configured to acquire sensor information;
a control section configured to estimate an operation of the artificial-intelligence-function-equipped display apparatus by artificial intelligence on a basis of the sensor information and control the operation; and
a presentation section configured to estimate a reason that the control section has performed the operation of the artificial-intelligence-function-equipped display apparatus by the artificial intelligence on the basis of the sensor information and cause the display section to present the reason.
